(19) United States
(12) Patent Application Publication
(10) Pub. No.: US 2026/0253147 A1
(43) Pub. Date: Aug. 27, 2026

(54) OPTIMIZATION FOR FARM PLANNING

(71) Applicants: Haitao Li, St. Louis, MO (US); Avinash Chaluvadi, St. Louis, MO (US)

(72) Inventors: Haitao Li, St. Louis, MO (US); Avinash Chaluvadi, St. Louis, MO (US)

(73) Assignee: The Curators of the University of Missouri, Columbia, MO (US)

(21) Appl. No.: 19/543,000

(22) Filed: Feb. 18, 2026

Related U.S. Application Data
(60) Provisional application No. 63/759,813, filed on Feb. 18, 2025.

(51) Int. Cl. G06Q 50/02; G06Q 10/04; G06Q 10/0631

(52) U.S. Cl. CPC G06Q 50/02; G06Q 10/04; G06Q 10/06312

(57) ABSTRACT

Farm planning optimization. A farm production database communicatively coupled to a farm optimization server stores one or more optimization constraints and an optimization objective. A coupled to the farm optimization server stores computer-executable instructions that, when executed, configure the farm optimization server for transmitting, to a client device, a first webpage configured for display by an internet-enabled application. The first webpage presents a plurality of farm production inputs to a user. The computer-executable instructions further configure the farm optimization server for receiving, from the client device, a plurality of input responses for the farm production inputs, generating one or more optimized farm production parameters using the optimization objective based on the optimization constraints and the farm production inputs, and transmitting, to the client device, a second webpage configured for display by the client device. The second webpage comprises the optimized farm production parameters.

### BACKGROUND

Conventional farm planning systems plan farm operations primarily around crop yield. For example, models attempt to ensure that the most crops are produced for a given window without further considerations of other factors, such as demand. However, farming operations include more than simply production. For example, farming operations also involve procurement to sell further on to other businesses or consumers, and distribution to satisfy market demands. As a result, decisions and constraints other than yield, such as demand, seasonal availability, storage, and distribution in a farm-to-fork supply chain, should be considered to optimize farm planning.

### SUMMARY

Aspects of the present disclosure provide a farm production optimization system based on an objective function utilizing decision variables and constraints. Aspects of the present disclosure also enable a farm operator to manually input data or upload a spreadsheet formatted for optimization to receive an output file including optimized farm production parameters.

In an aspect, a system for optimizing farm planning includes a farm optimization server coupled to a client device. The client device is configured for receiving webpages generated by an internet-enabled application and displaying the webpages. The system further includes a farm production database communicatively coupled to the farm optimization server. The farm production database stores one or more optimization constraints and an optimization objective. The system further includes a memory coupled to the farm optimization server. When executed by the farm optimization server, computer-executable instructions stored in the memory configure the farm optimization server for transmitting, to the client device, a first webpage configured for display by the internet-enabled application. The first webpage presents a plurality of farm production inputs to a user. The executable instructions also configure the farm optimization server for receiving, from the client device, a plurality of input responses for the plurality of farm production inputs and executing a farm optimization engine to generate one or more optimized farm production parameters based on the optimization objective, the one or more optimization constraints, and the plurality of farm production inputs. The executable instructions further configure the farm optimization server for transmitting, to the client device, a second webpage configured for display by the client device. The second webpage presents the one or more optimized farm production parameters.

In another aspect, a method for optimizing farm planning includes transmitting, by a farm optimization server, a first webpage to an internet-enabled application of a client device. The first webpage includes a plurality of farm production inputs. The method further includes receiving, by the farm optimization server, a plurality of input responses for the plurality farm production inputs and executing, by the farm optimization server, a farm optimization engine. Executing the farm optimization engine includes determining one or more optimization constraints, correlating the plurality of farm production inputs to one or more optimization variables, and generating one or more optimized farm production parameters based upon applying the one or more optimization variables and the one or more optimization constraints to an optimization function. The method also includes transmitting, by the farm optimization server, a second webpage to the internet-enabled application. The second webpage includes an export file comprising the one or more optimized farm production parameters.

In yet another aspect, a method for optimizing farm planning includes receiving, on a client device, a first webpage to display on an internet-enabled application of the client device. The first webpage includes a plurality of farm production inputs. The method further includes receiving, from a user, a plurality of input responses. The plurality of input responses includes general farm information, crop information, and time period information. The method also includes transmitting, to a farm optimization server, the plurality of input responses and receiving, on the client device, a second webpage to display on the internet-enabled application. The second webpage includes a plurality of optimized farm production parameters generated based on the plurality of input responses.

Other objects and features of the present invention will be in part apparent and in part pointed out herein.

### BRIEF DESCRIPTION OF THE DRAWINGS

FIG. 1 illustrates a block diagram illustrating a system for optimizing farm planning according to an embodiment.

FIG. 2 illustrates a flow diagram for the process of generating optimized farm parameters according to an embodiment.

FIG. 3 illustrates a user interface for initiating farm optimization planning according to an embodiment.

FIG. 4 illustrates a user interface for inputting farm production variables including selecting crops according to an embodiment.

FIG. 5 illustrates a user interface for inputting crop information according to an embodiment.

FIG. 6 illustrates a user interface for inputting production period information according to one embodiment.

FIG. 7 illustrates a flow diagram for the farm optimization process according to an embodiment.

FIG. 8 illustrates a block diagram illustrating a system for optimizing farm planning according to another embodiment.

Corresponding reference characters indicate corresponding parts throughout the drawings.

### DETAILED DESCRIPTION

The features and other details of the concepts, systems, and techniques sought to be protected herein will now be more particularly described. It will be understood that any specific embodiments described herein are shown by way of illustration and not as limitations of the disclosure and the concepts described herein. Features of the subject matter described herein can be employed in various embodiments without departing from the scope of the concepts sought to be protected.

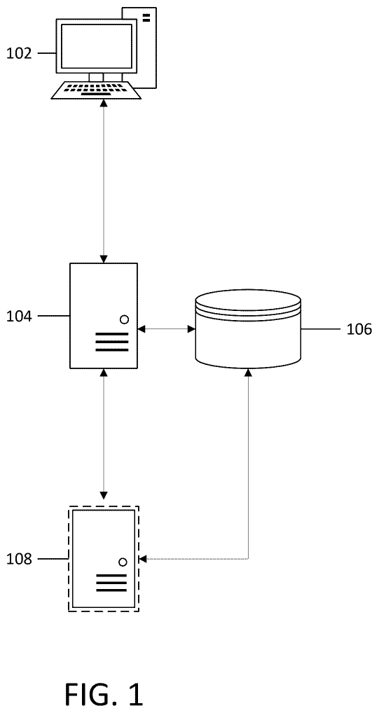

Referring to the figures and description below, a system for optimizing farm planning is disclosed. FIG. 1 is a block diagram illustrating the system. In some embodiments, the client device 102 comprises a desktop computer, laptop, a smart phone, or a tablet that is configured to connect to the internet. In some embodiments, a client device 102 is configured to receive and display web pages generated by an internet-enabled application. In some embodiments, the internet-enabled application comprises a web browser.

The farm optimization server 104 handles and responds to requests to generate optimal farm planning parameters, described further below, from the client device 102. In one embodiment, the client device 102 connects through a network to the farm optimization server 104. In some embodiments, the farm optimization server 104 comprises a web server responding to HTTP or HTTPS requests. In an embodiment, the farm optimization server 104 operates within the cloud. In some embodiments, the farm optimization server is a web server including authentication and a FastAPI backend interfacing with the farm production database 106.

In an embodiment, the farm optimization server 104 communicatively couples to a farm production database 106. In an embodiment, the farm production database connects to the farm optimization server 104 through a network. The farm production database 106 stores information related to farm production. Information includes produce types, a time period for production, required production inputs, water requirements, yields, demand, sale prices, supply costs, land requirements, and labor costs. In one embodiment, the farm production database 106 stores default values for crop information such as crop production times, time to harvest, and labor time. In some embodiments, the farm production database stores optimization model information such as information about constraints, objectives, and decision variables.

A farm optimization engine 108 models farm planning to generate the optimal farm planning parameters. In some embodiments, the farm optimization engine 108 comprises an optimization model of the farm production and procurement. In one or more embodiments, the farm optimization engine 108 is executed by the farm optimization server 104. In other embodiments, the farm optimization engine 108 operates independently of the farm optimization server 104 on cloud infrastructure or other infrastructure connected by network to the farm optimization server 104.

The optimization model, implemented by the farm optimization engine 108, optimizes profit while considering parameters focused beyond yield. For a farm production facility which also conducts procurement, the facility should also account for demand for various produce. As a result, an optimization model should not only account for parameters related to production such as labor costs, land area, and supply costs, but also parameters related to sales prices and demand. Further, other parameters such as both the seasonality for growing the produce and the seasonality for demand of the produce are incorporated into the model. The resulting optimization ensures that a farm production facility can appropriately meet demands while maximizing profit while producing many varieties of produce.

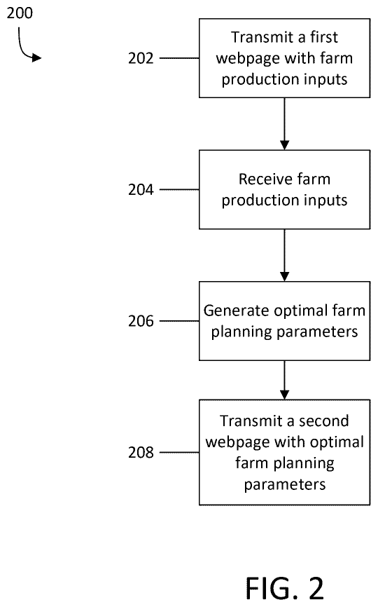

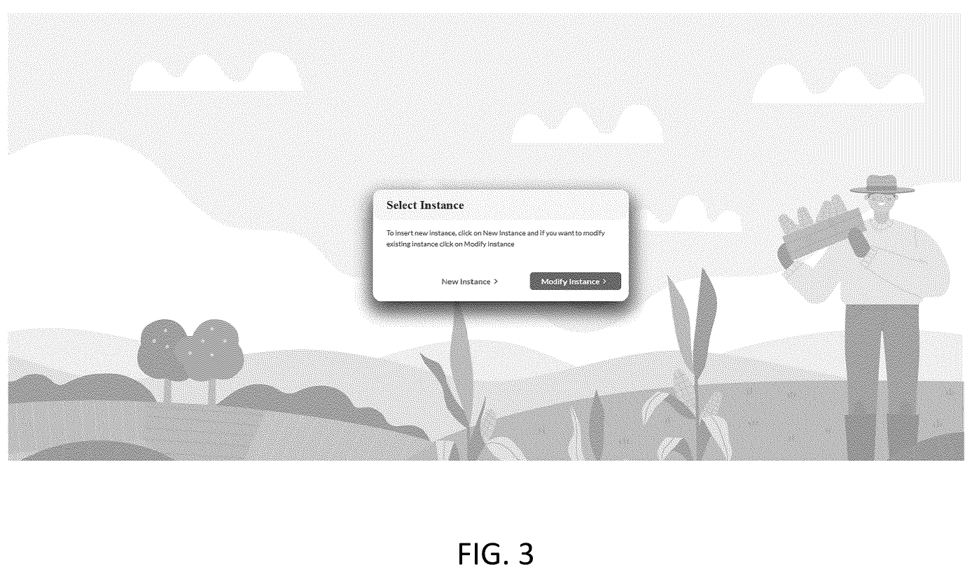

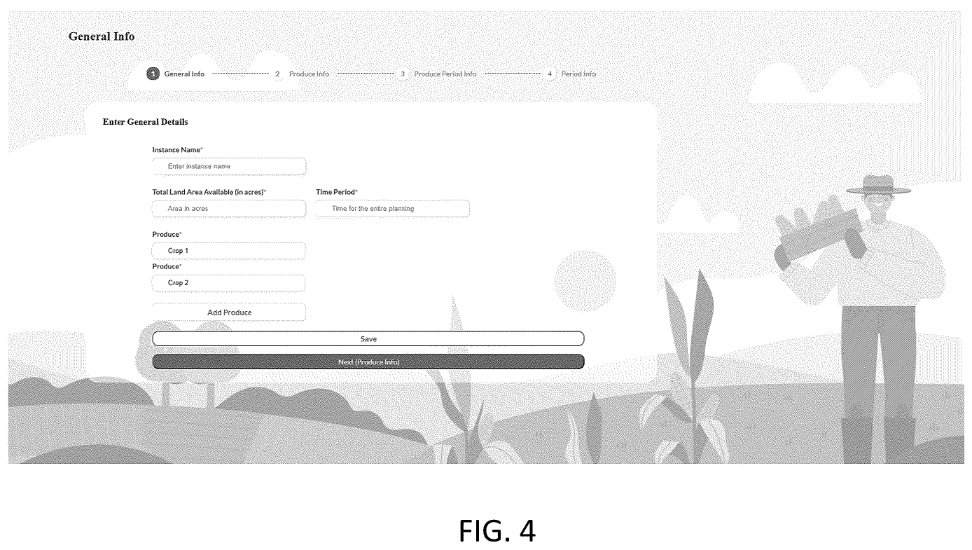

FIG. 2 shows an embodiment of the farm planning process 200 to generate farm planning parameters. At step 202, the farm optimization server 104 transmits a series of webpages to client device 102 for initializing the farm optimization process. FIG. 3 illustrates an example of a first webpage according to an embodiment within the initialization process. The user selects whether to create a new instance of farm planning or modify an existing instance. In some embodiments, a user may select to generate or modify a previously generated farm plan. For example, a new farm plan may be generated for a new year of growing. Alternatively, a user may need to update a previously generated farm plan because changes in the environment or economic updates. Thus, a user may change cost of labor due to a potential shortage or update due to unavailability of land that was expected to be used in the farm plan. In an embodiment, a subsequent interface includes one or more farm production inputs to which the user can input values, as shown in FIG. 4. When the user selects to generate a new instance of farm planning, the interface provides a set of farm production inputs regarding general farm information. For example, the farm production input includes farm information such as farmland area, purchase cost of supplies, a time period for production, and target produce.

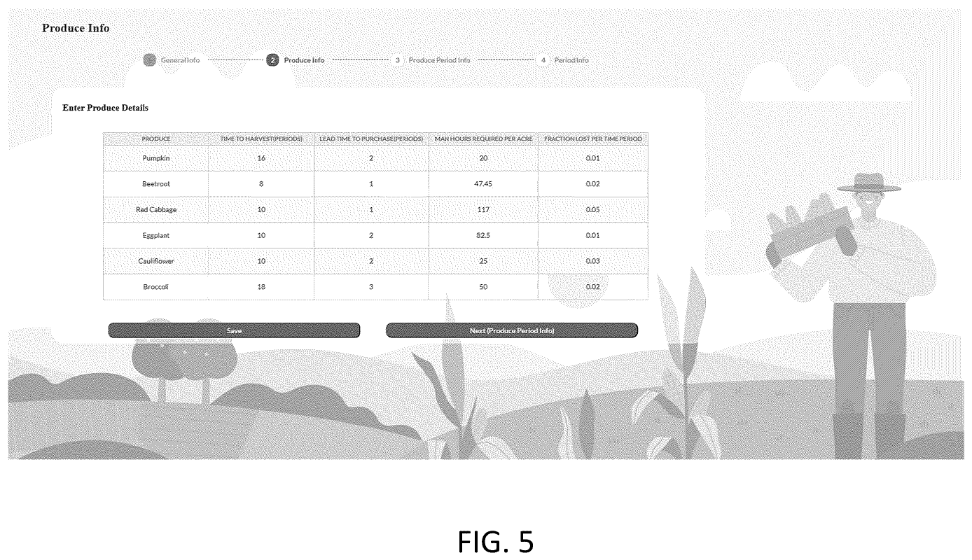

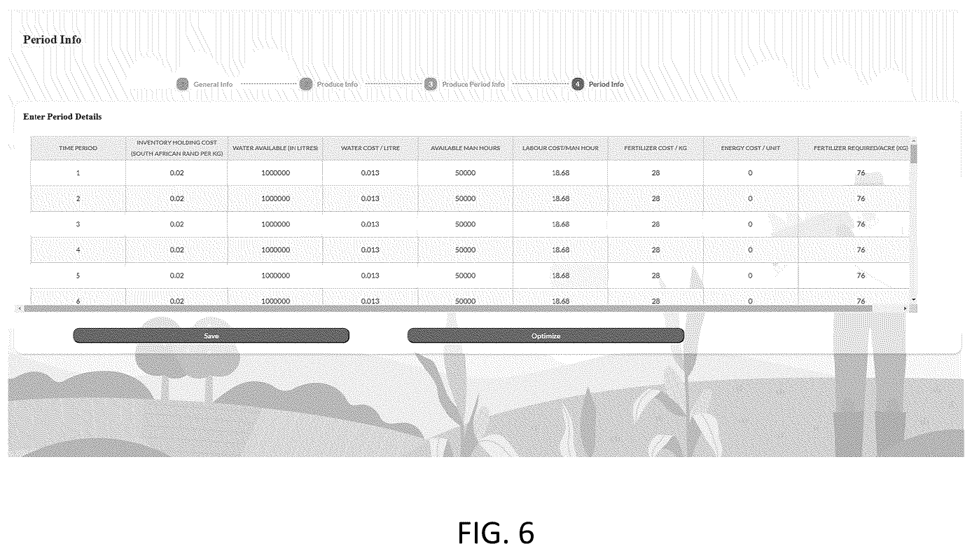

As shown in FIG. 5, the interface then guides the user to input crop information such as crop production times, time to harvest, lead time to purchase, labor costs, labor time and fraction of loss per time period. Farm production input may also include production period information such as inventory holding costs, water availability, water costs, available labor, labor costs, fertilizer costs, energy costs, and fertilization amount required. By considering broad sets of inputs including input costs, but also productivity and time limitations the model optimizes to meet demand. FIG. 6 shows another interface during initialization including a user interface for receiving production period information. The production period information may include water availability, labor costs, and labor availability.

In some embodiments, the initialization of step 202 is performed through dynamic webpage which guides the user through several prompts to enter farm production input, as described above. In other embodiments, the initialization may be performed through transmitting a series of webpages to the client device 102. For example, FIGS. 3-6 may be transmitted to the client device 102 as individual webpages rather than a single dynamic page to receive the farm production inputs. In other embodiments, the webpage includes a single input to upload a file with the farm production inputs. For example, a user may generate a spreadsheet, CSV, or JSON file formatted with the required information to generate optimal farm production parameters.

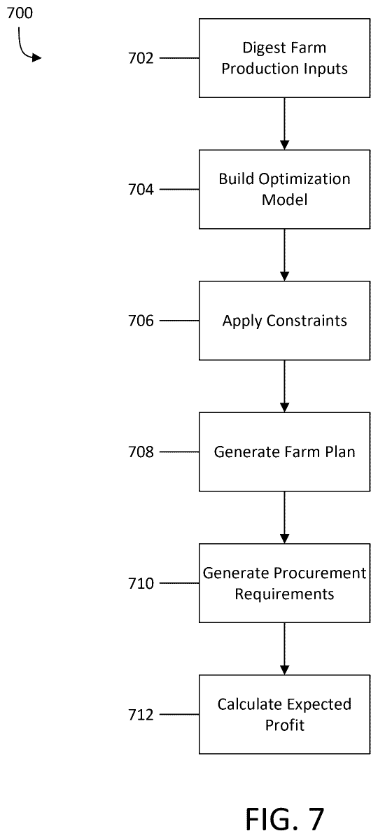

The farm planning process 200 continues at step 204 with the client device 102 transmitting input responses to the farm optimization server 104. Then, the farm optimization engine 108, operating either on the farm optimization server 104 or on other cloud infrastructure, receives the inputs and generates the optimal farm planning parameters at step 206. In one embodiment, the farm optimization server 104 automatically retrieves data from a data source such as an enterprise resource planning system (ERP), or an accounting system to populate the inputs. In some embodiments, the optimal farm planning parameters are generated through an optimization model using parameters based on the inputs, see FIG. 7 described further below. Then at step 208 the farm optimization server 104 transmits a second webpage including the optimal farm planning parameters to the client device 102. In some embodiments, the optimal farm planning parameters are presented as a part of the webpage transmitted to the client device 102. In other embodiments, the optimal farm planning parameters are transmitted through a file included with the second webpage. The file may be a plain text file, spreadsheet, or any other format suitable for displaying the generated optimal farm production parameters.

As previously described, the farm optimization engine 108 receives a set of inputs including sets and parameters from the operator to generate optimized farm decision variables including procurement, growing, production, and distribution. The optimized farm decision variables are generated to optimize an objective function while satisfying all the constraints to determine optimal farm production parameters. Table 1 describes the definitions of the variables and sets used by the model:

| | Definition |
|---|---|
| Sets | |
| P | Set of produce j |
| T | Set of time periods t (weeks) |
| Parameters | |
| Dⱼₜ | Demand (saleable capacity) for produce j ∈ |
| | P at the end of time period t ∈ T |
| Nⱼ | Number of time periods after which |
| | produce j ∈ P can be harvested |
| PCⱼₜ | Cost of purchasing one unit of produce j ∈ |
| | P during time period t ∈ T |
| Δⱼ | Lead time (in weeks) for purchase of |
| | produce j ∈ P |
| ICₜ | Inventory holding cost per unit of produce |
| | per time period t ∈ T |
| πⱼₜ | Selling price per unit of produce j E P during |
| | time period t ∈ T |
| Hⱼₜ | Yield (lbs.) of produce j E P per acre during |
| | time period t ∈ T |
| TWₜ | Total Units of water available in time period t ∈ |
| | T |
| Wⱼₜ | Units of water required to grow one unit of |
| | produce j E P during time period t ∈ T |
| WCₜ | Cost of water per unit during time period t ∈ T |
| Fₜ | Kg of fertilizer required per acre during time |
| | period t ∈ T |
| FCₜ | Cost of fertilizer per Kg during time period t ∈ T |
| Eⱼₜ | Units of energy required to grow one unit of |
| | produce j ∈ P during time period t ∈ T |
| ECₜ | Cost of energy per unit during time period t ∈ T |
| αₜ | Total available man hours during time period t |
| | ∈ T |
| Mⱼ | Man-hours required for produce j ∈ P per acre |
| LCₜ | Labor cost (for production) per man hour |
| | during time period t ∈ T |
| K | Total land area available (in acres) |
| Uⱼₜ | Land area occupied by produce j ∈ P after |
| | planting in time period t ∈ T (in acres) |
| Vₜ | Land area available for planting at the |
| | beginning of time period t ∈ T , prior to |
| | planting (in acres) |
| ωⱼ | Fraction of produce j ∈ P that is lost per time |
| | period |
| Decision Variables | |
| Xⱼₜ | 1 if produce j ∈ P is to be planted in time |
| | period t ∈ T; 0 otherwise |
| Yⱼₜ | Quantity of produce j ∈ P to be planted at the |
| | beginning of time period t ∈ T |
| Oⱼₜ | Quantity of produce j ∈ P to be ordered at the |
| | beginning of time period t ∈ T |
| Sⱼₜ | Quantity of produce j ∈ P to be shipped at the |
| | end of time period t ∈ T |
| Iⱼₜ | Quantity of produce j ∈ P to be stored in |
| | inventory at the end of time period t ∈ T |
| OCCₜ | Total Land area occupied after planting in time |
| | period t ∈ T (in acres) |

According to an embodiment, the objective function for the optimization model is to maximize the Profit P. As a result, the profit can be represented by two functions:

$$Profit = Revenue - [ Purchase Costs + Operating Costs + Labor Costs + Inventory Holding Costs ]$$

$${\sum }_{j ∈ P} {\sum }_{t ∈ T} {π}_{jt} \cdot {S}_{jt} - [ {\sum }_{j ∈ P} {\sum }_{t ∈ T} {PC}_{p t} \cdot {O}_{jt} + {\sum }_{j ∈ P} {\sum }_{t ∈ T} ( {W}_{jt} \cdot {WC}_{t} \cdot {Y}_{jt} + \frac{{F}_{t} \cdot {FC}_{t} \cdot {Y}_{jt}}{{H}_{jt}} ) + {\sum }_{t ∈ T} {\sum }_{j ∈ P} {LC}_{t} \cdot {M}_{j} \cdot {Y}_{jt} / {H}_{jt} + {\sum }_{t ∈ T} {\sum }_{j ∈ P} {IC}_{t} \cdot {I}_{jt} ]$$

An optimization model requires constraints, which represent limitations and requirements on farm operations. For example, optimized farm production cannot require usage of more water that exceeds the availability of water. Similarly, to meet demand, the amount of a given produce shipped must exceed the amount demanded. According to one embodiment, the optimization model includes constraints limiting the function including:
Inventory flow balancing: The sum of the quantity of produce shipped to meet demand of produce j∈P during period t∈T, and the quantity of that produce to be stored in inventory at the end of that period should be equal to the sum of the quantity of that produce planted ‘Nⱼ’ periods in advance, the quantity of that produce ordered ‘Δⱼ’ periods in advance, and the quantity of that produce available in inventory at the end of the previous period.

$${Y}_{j , t - {N}_{j}} + {O}_{j , t - {Δ}_{j} + 1} + {I}_{j , t - 1} * ( 1 - {ω}_{j} ) = {S}_{jt} + {I}_{jt} \qquad ∀ j ∈ P , t ∈ T$$

Demand Satisfaction: In each period t∈T, for each produce j∈P, the quantity shipped must be greater than or equal to the demand for that produce in that period.

$${S}_{jt} \geq {D}_{jt} \qquad ∀ j ∈ P , t ∈ T$$

Labor Constraint: In each period t∈T, the labor required should not exceed total labor available during that period.

$${\sum }_{j ∈ P} {M}_{j} \cdot ( {Y}_{jt} / {H}_{jt} ) \leq {α}_{t} \qquad ∀ t ∈ T$$

Water Usage: In each period t ET, the water required for production of all produce j∈P should not exceed total water availability during that period.

$${\sum }_{j ∈ P} {W}_{jt} \cdot {Y}_{jt} \leq {TW}_{t} \qquad ∀ t ∈ T$$

Land Usage: In any time period, the land used for production should be less than or equal to the land available at that point.

$${U}_{jt} = {\sum }_{τ = t - {N}_{j} + 1}^{t} ( {Y}_{j τ} / {H}_{j τ} ) \qquad ∀ j ∈ P , t ∈ T$$

$${OCC}_{t} = {\sum }_{j ∈ P} {U}_{jt} \qquad ∀ t ∈ T$$

$${V}_{t} = K - {OCC}_{t - 1} \qquad ∀ t ∈ T$$

In any time period t∈T, the total land required to grow all produce cannot exceed the total acreage available.

$${Y}_{jt} \leq {V}_{t} \cdot {H}_{jt} \cdot {X}_{jt} \qquad ∀ t ∈ T , j ∈ P$$

In some embodiments, the optimization constraints are derived from the farm production inputs. For example, the farm optimization inputs may include information on the amount of water available in total or for each time period. Similarly, the farm optimization inputs include information regarding land labor availability, and demand. In some embodiments, the demand information may be retrieved by the farm optimization server 104 from the farm production database 106 or another database storing historical farm data, market conditions, and/or macroeconomic indicators. For example, the farm optimization server 104 may retrieve data on consumer demand, market prices, consumer price index, or an inflation rate to forecast demand. It will be recognized that by determining values for the variables associated with the constraints the user may provide an optimization objective. In one example, a user may provide limited land availability for different periods of time to allow for certain areas of land to remain fallow. Alternatively, a user may place a water constraint such that the farm maximizes profit while meeting conservation objectives.

FIG. 7 is a flow diagram illustrating the farm optimization process 700 for generating the farm parameters. At step 702, the farm optimization engine 108 digests the farm production inputs. Using the defined function and constraints the optimization model can generate optimal farm planning parameters based on the user input. For example, a user may provide a set of input:
Produce: pumpkin, beetroot, red cabbage, eggplant, cauliflower, and broccoli.
Time Period: 1 year, split into 52 periods
Land Available: 10 Acres
Purchase lead times: Between 1 and 3 weeks for each produce type
Inventory Holding Cost: R0.02/kg
Labor Cost: R18.68/labor-hour
Fertilizer Cost: R28/kg
Fertilizer Required 76 kg/acre

TABLE 2
illustrates an input for the produce harvest
periods and labor hours required.

| Produce | Time to Harvest (Periods) | Labor hours required per acre |
|---|---|---|
| Pumpkin | 16 | 20 |
| Beetroot | 8 | 47.45 |
| Red Cabbage | 10 | 117 |
| Eggplant | 10 | 82.5 |
| Cauliflower | 10 | 25 |
| Broccoli | 18 | 50 |

In digesting the farm optimization inputs, the farm optimization engine 108 stores the farm optimization inputs in the farm production database 106. Additionally, the farm optimization engine 108 may identify relationships within the farm production parameters for implementation within the model. The farm optimization engine 108 may correlate crop information with time period information. For example, a crop may be associated with certain time periods for growing requiring a correlation between the crop information and the time period information.

The farm optimization process 700 continues with building an optimization model based on the farm production inputs at step 704. As described above, the model includes a calculation of profit based on costs such as purchase costs, operating costs, labor costs, and inventory holding costs subtracted from the revenue. Thus, for each crop the farm optimization model determines the potential revenue and costs for each time period in the set of time periods for growing.

At step 706 of the farm optimization process 700, the farm optimization engine 108 applies the constraints to the model with the farm optimization inputs. In this way, the farm optimization engine 108 ensures that the recommended farm plan complies with real-world limitations such as water usage, land usage, and labor availability. The constraints enable the farm optimization engine 108 to generate a farm plan that only uses water up to the maximum, only uses water up to the total of available land, and only requires labor up to the limit of availability while meeting the demand for each produce.

Continuing with the farm optimization process 700, the farm optimization engine 108 generates a farm plan for planting at step 708. Using the provided input, the model generates an optimal plan for what to plant, when to plant, and how much to plant. In this way, the farm optimization engine 108 provides a planting and procurement schedule including a crop type, a quantity to plant, a land area allocation, procurement quantities, and a time period for planting. For example:
PERIOD 2:
Total Land Available for Planting at the beginning of period 2 (V[t]):
To Plant:
1963.93 kg of Pumpkin across 0.33 acres
Total Land Used by Pumpkin at the end of period 2 (UOut): 0.87
884.94 kg of Beetroot across 0.06 acres
Total Land Used by Beetroot at the end of period 2 (UOut): 1.32
3427.00 kg of Red Cabbage across 0.24 acres
Total Land Used by Red Cabbage at the end of period 2 (UOut): 0.24
4161.00 kg of Eggplant across 0.17 acres
Total Land Used by Eggplant at the end of period 2 (UOut): 0.17
688.76 kg of Cauliflower across 0.09 acres
Total Land Used by Cauliflower at the end of period 2 (UOut): 0.34
577.32 kg of Broccoli across 0.20 acres
Total Land used by Broccoli at the end of period 2 (UOut): 1.47
TOTAL LAND OCCUPIED AT THE END OF PERIOD 2:4.43

Then at step 710 of the farm optimization process 700, the farm optimization engine 108 generates procurement requirements. Through this step, the model provides guidance for procurement to meet the needs of the operation including what to purchase, when to purchase, and how much to purchase. In this way, the planting schedule and the procurement schedule are jointly optimized by the farm optimization engine based on both production constraints and demand constraints to maximize farm profit across the plurality of time periods. For example:
PERIOD 4:
3317.00 kg of Pumpkin
0.00 kg of Beetroot
0.00 kg of Red Cabbage
4761.00 kg of Eggplant
2819.00 kg of Cauliflower
0.000 kg of Broccoli
Period 10:
0.00 kg of Pumpkin
19457.50 kg of Beetroot
0.00 kg of Red Cabbage
0.00 kg of Eggplant
0.00 kg of Cauliflower
0.00 kg of Broccoli
Period 11:
0.00 kg of Pumpkin
19068.35 kg of Beetroot
0.00 kg of Red Cabbage
0.00 kg of Eggplant
2084.74 kg of Cauliflower
0.00 kg of Broccoli

Finally, the farm optimization engine 108 provides a calculation of the expected profit at step 712 of the farm optimization process 700. The optimization model provides the expected profit based on a breakdown of the revenue and costs. For example:
Revenue: R6646668.50
PurchaseCost: R5334106.50
OperatingCost: R275897.68
LaborCost: R30214.90
InventoryCost: R10732.17
NET PROFIT: R995717.25

In some embodiments, the farm optimization engine 108 generates an export file with the farm plan such as a spreadsheet. In this way, the farm optimization server 104 provides a single file including both planting recommendation, purchase requirements, and then the total revenue, costs, and ultimate profit for the farm.

In one embodiment, the farm optimization server 104 continuously monitors the farm production database 106 or other databases such as an accounting or ERP system to provide updates to the farm plan. For example, the farm optimization server 104 may retrieve information from a database indicating a change in the price for a crop that was included in the farm plan, but not yet planted in the current time period. In response to a drop in the price, the farm optimization server 104 executes the farm optimization engine 108 to determine a new farm plan based on the new price. Similarly, the farm optimization server 108 may identify that the cost or availability of labor has changed, requiring a change to the farm plan. As a result, the system reacts to a fluid demand market to ensure that the farm plan is optimized for the most recent market and farm conditions.

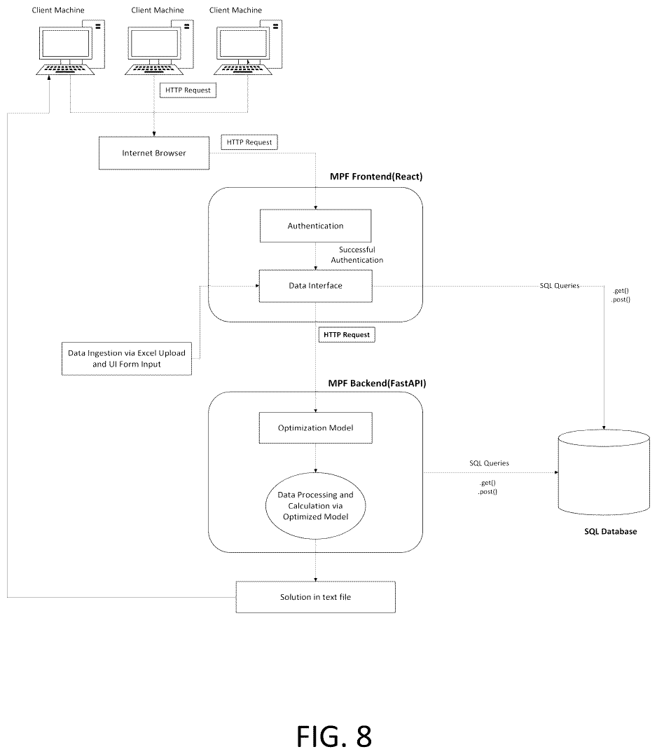

Thus, by leveraging an optimization model, a farm production facility can optimize all production operations, procurement, and distribution. The model enables the facility to meet the demands based on various produce needs while maximizing profit because the model considers external costs as well as produce demand. FIG. 8 illustrates a block diagram illustrating a system for optimizing farm planning according to another embodiment. As shown in FIG. 8, a process embodying aspects of the present disclosure begins with multiple client machines, each accessing the system via an internet browser. The multiple clients send HTTP requests to interact with the applications. Users on these client machines can upload data via an Excel file, for example, or enter information through a user interface form on the application.

Embodiments of the present disclosure may comprise a special purpose computer including a variety of computer hardware, as described in greater detail herein.

For purposes of illustration, programs and other executable program components may be shown as discrete blocks. It is recognized, however, that such programs and components reside at various times in different storage components of a computing device, and are executed by a data processor(s) of the device.

Although described in connection with an example computing system environment, embodiments of the aspects of the invention are operational with other special purpose computing system environments or configurations. The computing system environment is not intended to suggest any limitation as to the scope of use or functionality of any aspect of the invention. Moreover, the computing system environment should not be interpreted as having any dependency or requirement relating to any one or combination of components illustrated in the example operating environment. Examples of computing systems, environments, and/or configurations that may be suitable for use with aspects of the invention include, but are not limited to, personal computers, server computers, hand-held or laptop devices, multiprocessor systems, microprocessor-based systems, set top boxes, programmable consumer electronics, mobile telephones, network PCs, minicomputers, mainframe computers, distributed computing environments that include any of the above systems or devices, and the like.

Embodiments of the aspects of the present disclosure may be described in the general context of data and/or computer-executable instructions, such as program modules, stored one or more tangible, non-transitory storage media and executed by one or more processors or other devices. Generally, program modules include, but are not limited to, routines, programs, objects, components, and data structures that perform particular tasks or implement particular abstract data types. Aspects of the present disclosure may also be practiced in distributed computing environments where tasks are performed by remote processing devices that are linked through a communications network. In a distributed computing environment, program modules may be located in both local and remote storage media including memory storage devices.

In operation, processors, computers and/or servers may execute the computer-executable instructions (e.g., software, firmware, and/or hardware) such as those illustrated herein to implement aspects of the invention.

Embodiments may be implemented with computer-executable instructions. The computer-executable instructions may be organized into one or more computer-executable components or modules on a tangible processor readable storage medium. Also, embodiments may be implemented with any number and organization of such components or modules. For example, aspects of the present disclosure are not limited to the specific computer-executable instructions or the specific components or modules illustrated in the figures and described herein. Other embodiments may include different computer-executable instructions or components having more or less functionality than illustrated and described herein.

The order of execution or performance of the operations in accordance with aspects of the present disclosure illustrated and described herein is not essential, unless otherwise specified. That is, the operations may be performed in any order, unless otherwise specified, and embodiments may include additional or fewer operations than those disclosed herein. For example, it is contemplated that executing or performing a particular operation before, contemporaneously with, or after another operation is within the scope of the invention.

When introducing elements of the invention or embodiments thereof, the articles “a,” “an,” “the,” and “said” are intended to mean that there are one or more of the elements. The terms “comprising,” “including,” and “having” are intended to be inclusive and mean that there may be additional elements other than the listed elements.

Not all of the depicted components illustrated or described may be required. In addition, some implementations and embodiments may include additional components. Variations in the arrangement and type of the components may be made without departing from the spirit or scope of the claims as set forth herein. Additional, different or fewer components may be provided and components may be combined. Alternatively, or in addition, a component may be implemented by several components.

The above description illustrates embodiments by way of example and not by way of limitation. This description enables one skilled in the art to make and use aspects of the invention, and describes several embodiments, adaptations, variations, alternatives and uses of the aspects of the invention, including what is presently believed to be the best mode of carrying out the aspects of the invention. Additionally, it is to be understood that the aspects of the invention are not limited in its application to the details of construction and the arrangement of components set forth in the following description or illustrated in the drawings. The aspects of the invention are capable of other embodiments and of being practiced or carried out in various ways. Also, it will be understood that the phraseology and terminology used herein is for the purpose of description and should not be regarded as limiting.

It will be apparent that modifications and variations are possible without departing from the scope of the invention defined in the appended claims. As various changes could be made in the above constructions and methods without departing from the scope of the invention, it is intended that all matter contained in the above description and shown in the accompanying drawings shall be interpreted as illustrative and not in a limiting sense.

In view of the above, it will be seen that several advantages of the aspects of the invention are achieved and other advantageous results attained.

The Abstract and Summary are provided to help the reader quickly ascertain the nature of the technical disclosure. They are submitted with the understanding that they will not be used to interpret or limit the scope or meaning of the claims. The Summary is provided to introduce a selection of concepts in simplified form that are further described in the Detailed Description. The Summary is not intended to identify key features or essential features of the claimed subject matter, nor is it intended to be used as an aid in determining the claimed subject matter.

1. A system for optimizing farm planning comprising:
a farm optimization server coupled to a client device, the client device configured for receiving webpages generated by an internet-enabled application and displaying the webpages;
a farm production database communicatively coupled to the farm optimization server, the farm production database storing one or more optimization constraints and an optimization objective; and
a memory storing computer-executable instructions that, when executed by the farm optimization server, configure the farm optimization server for:
transmitting, to the client device, a first webpage configured for display by the internet-enabled application, the first webpage presenting a plurality of farm production inputs to a user;
receiving, from the client device, a plurality of input responses for the plurality of farm production inputs;
executing a farm optimization engine to generate one or more optimized farm production parameters based on the optimization objective, the one or more optimization constraints, and the plurality of farm production inputs; and
transmitting, to the client device, a second webpage configured for display by the client device, the second webpage presenting the one or more optimized farm production parameters.

2. The system of claim 1, wherein the one or more optimized farm production parameters comprise a planting schedule and a procurement schedule that are jointly optimized based on both production constraints and demand constraints to maximize farm profit across the plurality of time periods, the planting schedule specifying, for each time period, a crop type, a quantity to plant, and a land area allocation, and the procurement schedule specifying, for each time period, a crop type and a quantity to purchase.

3. The system of claim 1, wherein the second webpage further comprises a farm profit and the computer-executable instructions stored in the memory, when executed by the farm optimization server, further configure the farm optimization server for:
determining, before transmitting to the client device the second webpage, the farm profit based on the one or more optimized farm production parameters.

4. The system of claim 3, wherein the farm profit is calculated by subtracting farm purchase costs, farm operating costs, farm labor costs, and inventory holding costs from farm revenue.

5. The system of claim 1, wherein the plurality of farm production inputs comprises at least one of farm a farm land area, a purchase cost of supplies, a time period for production, or a target produce.

6. The system of claim 1, wherein the one or more optimization constraints comprise at least one of an inventory flow balancing constraint, a demand satisfaction constraint, a labor constraint, a water usage constraint, or a land usage constraint.

7. The system of claim 1, wherein the one or more optimized farm production parameters comprises procurement requirements and planting information, the planting information comprising a crop and a land area associated with each time period of a plurality of time periods.

8. The system of claim 1, wherein executing the farm optimization engine comprises:
determining one or more optimization constraints;
correlating the plurality of farm production inputs to one or more optimization variables; and
applying the one or more optimization variables and optimization constraints to an optimization function to generate the one or more optimized farm production parameters.

9. The system of claim 1, wherein the computer-executable instructions stored in the memory, when executed by the farm optimization server, further configure the farm optimization server for:
continuously monitoring at least one of the farm production database, an accounting system, or an enterprise resource planning (ERP) system to detect a change in at least one of a crop price, a labor cost, or labor availability associated with the plurality of input responses;
in response to detecting the change, automatically executing the farm optimization engine to regenerate the one or more optimized farm production parameters based on the optimization objective, the one or more optimization constraints, the plurality of farm production inputs, and the detected change; and
transmitting, to the client device, an updated webpage presenting the regenerated optimized farm production parameters.

10. A method for optimizing farm planning comprising:
transmitting, by a farm optimization server, a first webpage to an internet-enabled application of a client device, wherein the first webpage comprises a plurality of farm production inputs;
receiving, by the farm optimization server, a plurality of input responses for the plurality farm production inputs;
executing, by the farm optimization server, a farm optimization engine, wherein executing the farm optimization engine comprises:
determining one or more optimization constraints;
correlating the plurality of farm production inputs to one or more optimization variables; and
generating one or more optimized farm production parameters based upon applying the one or more optimization variables and the one or more optimization constraints to an optimization function; and
transmitting, by the farm optimization server, a second webpage to the internet-enabled application, wherein the second webpage comprises an export file comprising the one or more optimized farm production parameters.

11. The method of claim 10, wherein the plurality of input responses comprises at least one of a CSV file, a JSON file, or a spreadsheet.

12. The method of claim 10, wherein the optimization constraints comprise at least one of an inventory flow balancing constraint, a demand satisfaction constraint, a labor constraint, a water usage constraint, or a land usage constraint.

13. The method of claim 10, wherein the plurality of farm production inputs comprises at least one of farm a farm land area, a purchase cost of supplies, a time period for production, or a target produce.

14. The method of claim 10, wherein the one or more optimized farm production parameters comprises procurement requirements and planting information, the planting information comprising a crop and a land area associated with each time period of a plurality of time periods.

15. The method of claim 10, wherein the second webpage further comprises a farm profit and the method further comprises:
determining, before transmitting to the client device the second webpage, the farm profit based on the one or more optimized farm production parameters.

16. A method for optimizing farm planning comprising:
receiving, on a client device, a first webpage to display on an internet-enabled application of the client device, wherein the first webpage comprises a plurality of farm production inputs;
receiving, from a user, a plurality of input responses, the plurality of input responses comprising general farm information, crop information, and time period information;
transmitting, to a farm optimization server, the plurality of input responses; and
receiving, on the client device, a second webpage to display on the internet-enabled application, wherein the second webpage comprises a plurality of optimized farm production parameters generated based on the plurality of input responses.

17. The method of claim 16, further comprising receiving, from the farm optimization server, an export file comprising the plurality of optimized farm production parameters.

18. The method of claim 16, wherein the general farm information comprises a farmland area, a purchase cost of supplies, a time period for production, and one or more target produce.

19. The method of claim 16, wherein the crop information comprises a crop production time, a time to harvest, a lead time to purchase, one or more labor costs, a labor time and a fraction of loss per time period.

20. The method of claim 16, wherein the plurality of optimized farm production parameters comprises procurement requirements and planting information, the planting information comprising a crop and a land area associated with each time period of a plurality of time periods.
